(19) United States
(12) Patent Application Publication
(10) Pub. No.: US 2014/0239029 A1
(43) Pub. Date: Aug. 28, 2014

(54) VEHICLE BICYCLE RACK

(71) Applicant: Chin-Shui Chang, Changhua (TW)

(72) Inventor: Chin-Shui Chang, Changhua (TW)

(73) Assignee: WEI CHIEH BICYCLE CO., LTD., CHANGHUA (TW)

(21) Appl. No.: 13/894,131

(22) Filed: May 14, 2013

(30) Foreign Application Priority Data
Feb. 27, 2013 (TW) 102203704

(51) Int. Cl. B60R 9/10

(52) U.S. Cl. CPC B60R 9/10
USPC 224/560

(57) ABSTRACT

An improved vehicle bicycle rack structure includes a hook and a connecting body. The hook has a rack that includes the upper and lower tubes for a hook shell, which can receive the connecting body and secure it by soldering the connecting portion, so that the structure of hook shell of the hook can be strengthened because the connecting body is received therein. Also, the hook shell is formed at the rear ends of the upper and lower tubes as one piece to prevent the hook shell from falling off from the rack.

### FIELD OF THE INVENTION

The present invention relates to a vehicle bicycle rack, and more particularly to an improved structure of a metal vehicle bicycle rack.

### BACKGROUND OF THE INVENTION

Referring to FIG. 7 for a conventional vehicle bicycle rack, which includes a rack 30 having an upper and lower tubes 31, 32, and a hook 33 is disposed and secured at rear ends of the upper and lower tubes 31, 32. The hook 33 is used for assembling a hub structure.

However, the conventional vehicle bicycle rack is disadvantageous because the hook 33 is soldered at the upper and lower tubes 31, 32 of the rack 30. More specifically, the hook 33 is merely soldered at the upper and lower tubes 31, 32 through a “point-to-point” connection, so the structural strength therebetween is reduced after the soldering process and the hook 33 may break from the upper and lower tubes 31, 32, which leads to a serious safety concern.

### SUMMARY OF THE INVENTION

The technical problem the present invention wants to solve is that the hook is merely soldered at the upper and lower tubes through a “point-to-point” connection, so the structural strength therebetween is reduced after the soldering process and the hook may break from the upper and lower tubes, which leads to a serious safety concern.

The present invention provides a metal vehicle bicycle rack includes a hook and a connecting body. A rack has a upper and lower tubes extending at a rear end to form a hollow hook shell, and the hook shell has an open interior portion and a protruding connecting portion. The connecting body is shaped corresponding to the interior portion of the hook shell and has a recessed U-shaped opening. In other words, the hook provides the hook shell to receive the connecting body, and the connecting portion can be soldered together, so that the connecting body can be enclosed in the hook shell. Finally, the vehicle bicycle rack can be obtained by further soldering and polishing.

Comparing with the prior arts, the present invention is advantageous because the hook has the rack that includes the upper and lower tubes for the hook shell, which can receive the connecting body and secure it by soldering the connecting portion, so that the hook shell of the hook can be strengthened because the connecting body is received therein. Also, the hook shell is formed at the rear ends of the upper and lower tubes as one piece to prevent the hook shell from falling off from the rack.

### BRIEF DESCRIPTION OF THE DRAWINGS

FIG. 1 illustrates a three-dimensional view of the present invention.

FIG. 2 illustrates a three-dimensional exploded view of the present invention.

FIG. 3 illustrates a sectional view of the present invention.

FIG. 4 illustrates a schematic view of soldering the rack structure in the present invention.

FIG. 5 illustrates a schematic view of soldering and polishing the rack structure in the present invention.

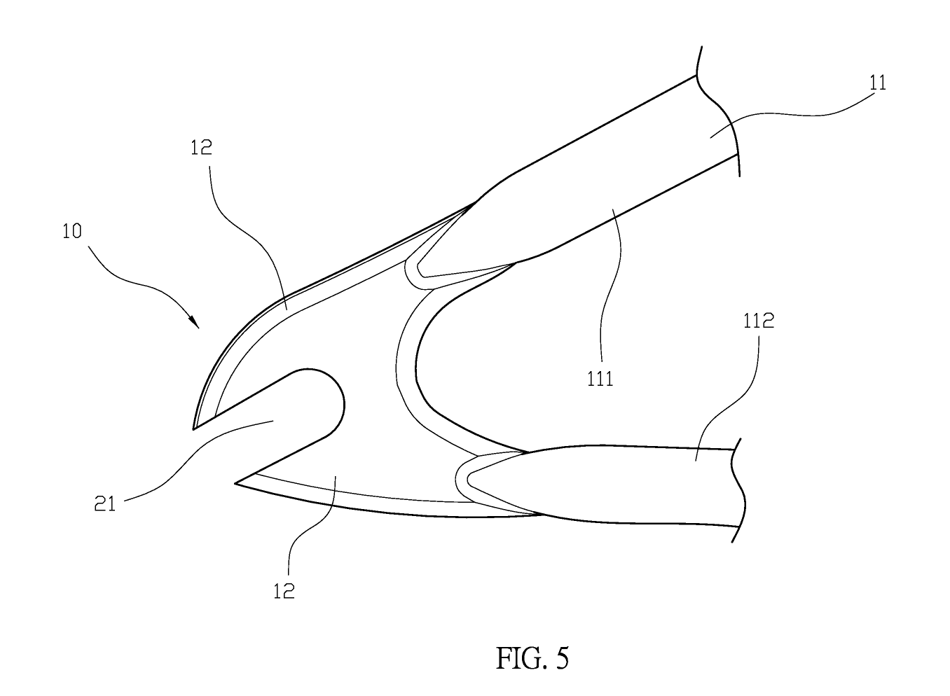

FIG. 6 illustrates a schematic view of the rack structure in use the present invention.

FIG. 7 illustrates a conventional three-dimensional view of the rack structure.

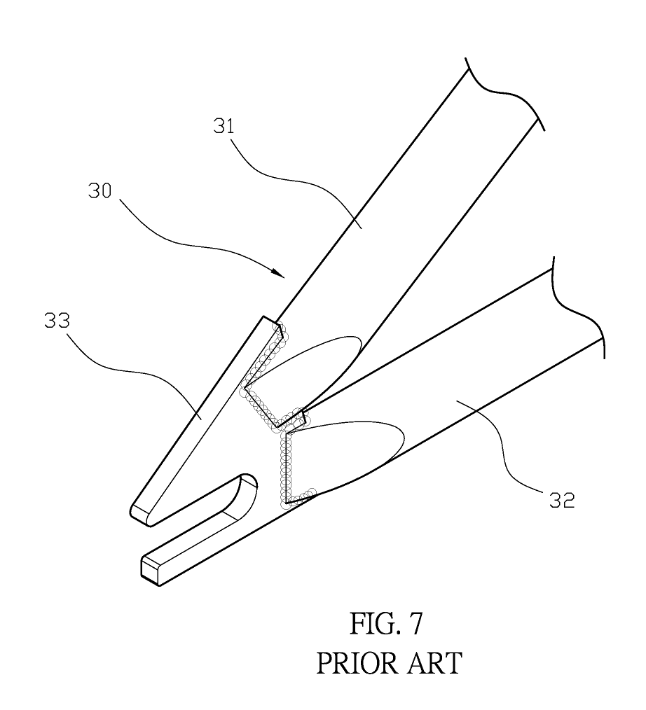

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

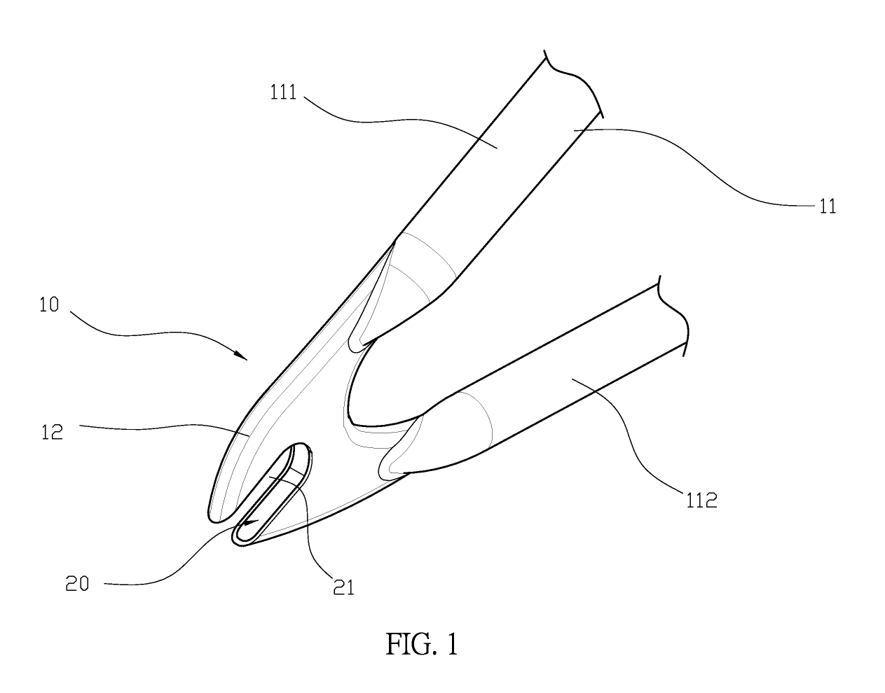

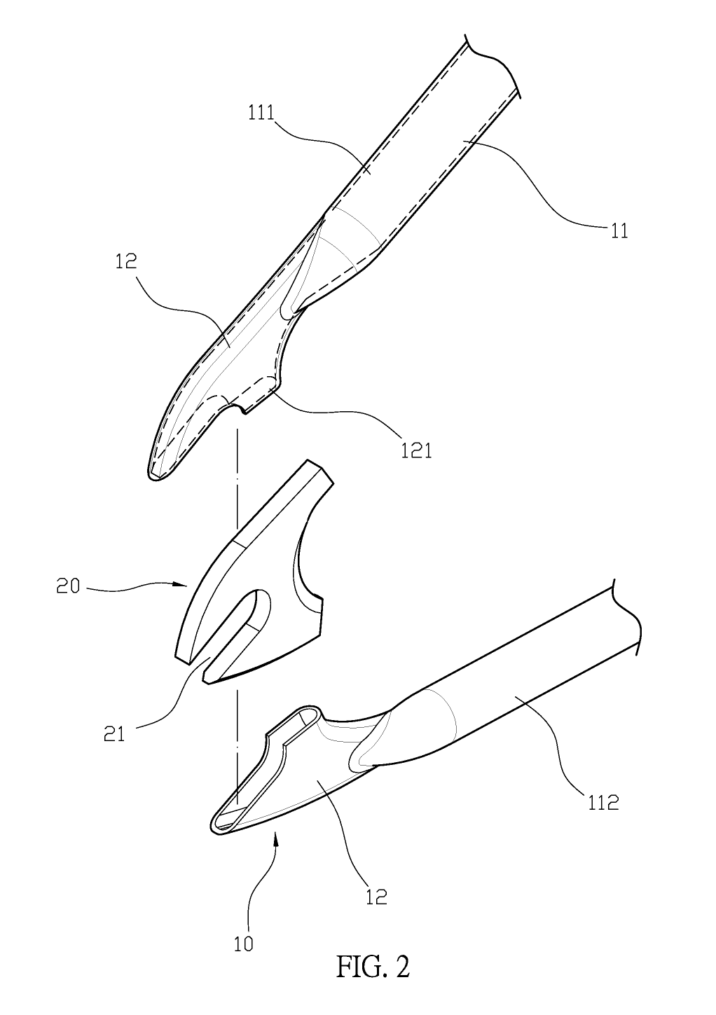

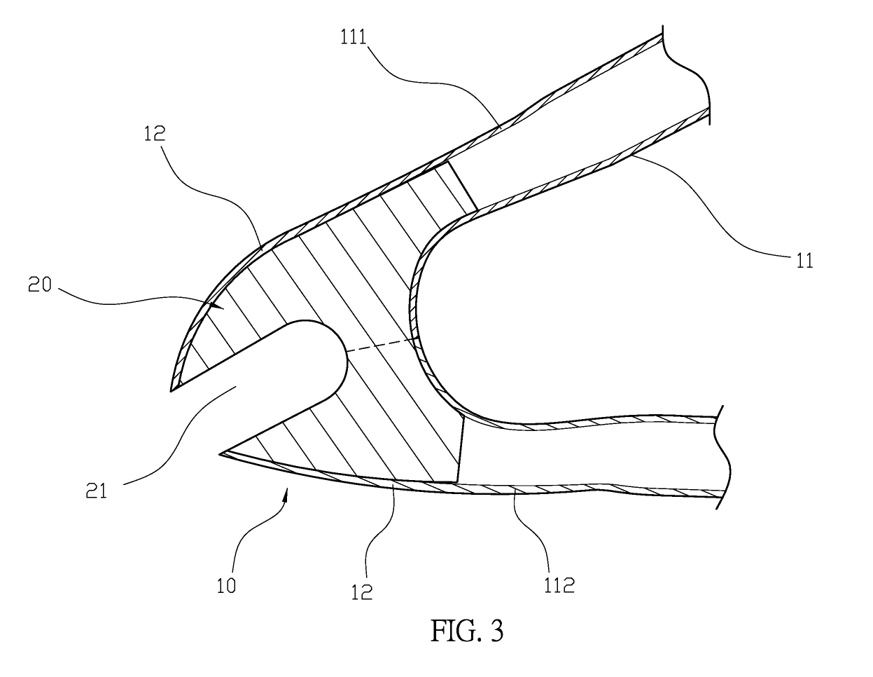

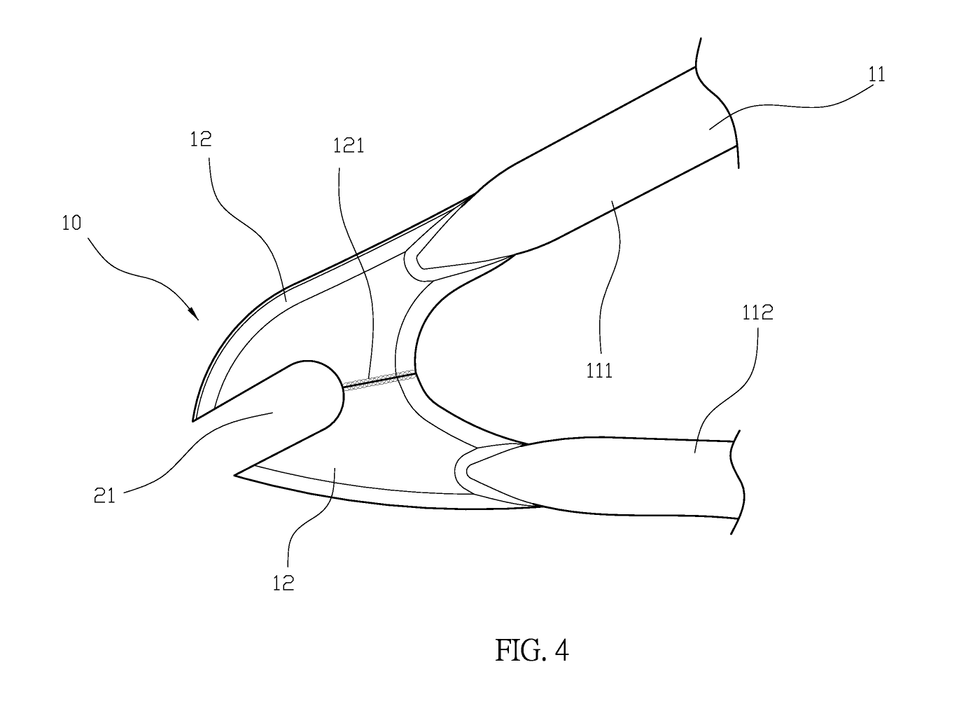

Referring to FIGS. 1 to 4, a metal vehicle bicycle rack includes a hook 10 and a connecting body 20. A rack 11 has a upper and lower tubes (111, 112) extending at a rear end to form a hollow hook shell 12, and the hook shell 12 has an open interior portion and a protruding connecting portion 121. The connecting body 20 is shaped corresponding to the interior portion of the hook shell 12 and has a recessed U-shaped opening 21. In other words, the hook 10 provides the hook shell 12 to receive the connecting body 20, and the connecting portion 121 can be soldered together, so that the connecting body 20 can be enclosed in the hook shell 12. Finally, the vehicle bicycle rack can be obtained by further soldering and polishing.

Moreover, molten metal is filled in the space between the hook shell 12 and the connecting body 20, and after the molten metal is cooled down, outer surface of the connecting body 20 can be secured with inner walls of the hook shell 12.

Also, before enclosing the connecting body 20 with the hook shell 12, the surface of the connecting body 20 can be coated with different kinds of glues to fill the space between the hook shell 12 and the connecting body 20 and further secure the outer surface of the connecting body 20 with the inner walls of the hook shell 12.

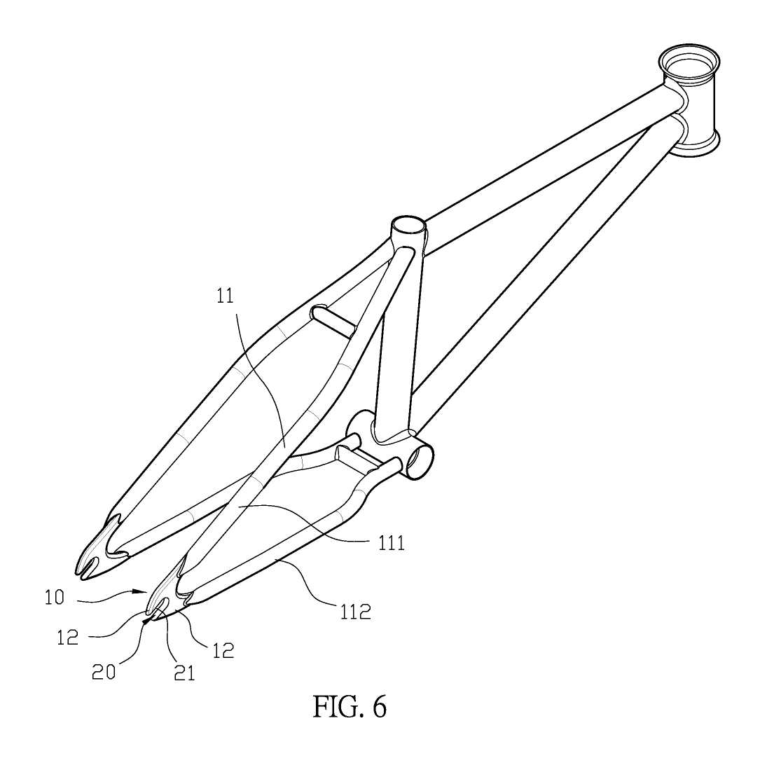

Referring to FIG. 6, the rack 11 is used for bicycles using the upper and lower tubes (111, 112) for the hook 10 at the rear ends to form a hub structure, which will be disposed into a space between two hook shells 12 and restricted in the opening 21 of the connecting body 20 to complete the assembly of the rack 11 with hook 10 and the hub structure.

According to the embodiments described above, the present invention is advantageous because the hook 10 has the rack 11 that includes the upper and lower tubes (111, 112) for the hook shell 12, which can receive the connecting body 20 and secure it by soldering the connecting portion 121, so that the hook shell 12 of the hook 10 can be strengthened because the connecting body 20 is received therein. Also, the hook shell 12 is formed at the rear ends of the upper and lower tubes (111, 112) as one piece to prevent the hook shell 12 from falling off from the rack 11.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A metal vehicle bicycle rack, comprising:
a hook, extended from an upper and lower tubes of a rack and having a hollow hook shell, wherein the hook shell has an open interior and a protruding connecting portion; and
a connecting body, which is shaped corresponding to the interior of the hook shell and has a recessed U-shaped opening;
wherein the hook shell is used to receive the connecting body, and the connecting portion is soldered together, so that the connecting body is enclosed in the hook shell.

2. The metal vehicle bicycle rack of claim 1, wherein molten metal is filled in a space between the hook shell and the connecting body, and after the molten metal is cooled down, outer surface of the connecting body is secured with inner walls of the hook shell.

3. The metal vehicle bicycle rack of claim 2, wherein surface of the connecting body is coated with different kinds of glues to fill the space between the hook shell and the connecting body and further secure the outer surface of the connecting body with the inner walls of the hook shell.
